(19) United States
(12) Patent Application Publication
(10) Pub. No.: US 2005/0016851 A1
(43) Pub. Date: Jan. 27, 2005

(54) Microchemical method and apparatus for synthesis and coating of colloidal nanoparticles

(76) Inventors: Klavs F. Jensen, Lexington, MA (US); Saif A. Khan, Cambridge, MA (US)

Correspondence Address: Choate, Hall & Stewart, Exchange Place, 53 State Street, Boston, MA, 02109, US

(21) Appl. No.: 10/626,436

(22) Filed: Jul. 24, 2003

(51) Int. Cl. B32B 5/02; B01J 10/02

(52) U.S. Cl. 204/471; 422/129

(57) ABSTRACT

The present invention represents a radical departure from most conventional macro-scale batch processing methods employed to synthesize and coat colloidal nanoparticles. Synthesis and coating are in series and in-situ, obviating the need for numerous cumbersome, and often expensive intermediate-processing steps. In one embodiment, the invention is a method and apparatus for synthesizing colloidal nanoparticles. In another embodiment, the invention is a method and apparatus for enabling coating of colloidal nanoparticles using an electrophoretic switch for contacting and separating said colloid nanoparticles.

### GOVERNMENT SUPPORT

This research was supported by Grants CA-28824, 25848, CA-08748, CA-39821, CA-GM-72231, GM-18248, CA-62948, F32CA81704, and AI0-9355 from the National Institutes of Health, and Grant CHE-9504805 from the National Science Foundation. Furthermore, this research was supported by Postdoctoral Fellowships for Chul Bom Lee (U.S. Army, Grant DAMD 17-98-1-8155), Shawn J. Stachel (NIH, Grant F32CA81704), and Mark D. Chappell. (NIH, Grant, F32GM199721)

### FIELD OF THE INVENTION

The present invention relates generally to microfluidic chemical systems for synthesis and coating of colloidal nanoparticles. In particular, the invention accomplishes continuous synthesis of colloidal nanoparticles and in-situ coating of their surfaces with various functionalities, through novel reactant-contacting schemes.

### BACKGROUND OF THE INVENTION

Colloidal nanoparticles have innumerable applications in almost all fields of science, and are ubiquitous in materials science, chemistry and biology. Industrial applications of colloidal spheres of silica and titania, for example, include adhesion and lubrication technology, pigments, catalysis, thin films for photovoltaic, electrochromic, photochromic, electroluminescent devices, sensors, foods, health-care, anti-reflective coatings, chromatography, ceramics, optoelectronics, photonic band-gap (PBG) materials, etc. Further applications are applicable when the surfaces of the particles are modified or coated in some manner by other functionalities. Such ‘nanocomposites’ find numerous applications in fields ranging from opto-electronics and lasers to drug-delivery and biotechnology. The preparation of well-defined colloidal nanoparticles of controlled composition is of great importance, because of the potential use of such particles in the wide variety of fields.

Applying coating techniques for nanoparticles involves difficulties which do not exist in coating processes of flat surfaces, due to the differential physical characteristics of spherical systems. Although techniques based on sol-gel procedures for the preparation of silica are well known (Stober, Fink & Bohn, Colloidal Interface Sci. 26, 62 (1968)), and have been applied successfully for the preparation of a coating for a flat surface (Brinker, et al., J of Non-Crystalline Solids, 147, 424 (1992); Brinker et al., Thin Solid Films 201, 97 (1991)), the art has failed to disclose a simple method for coating spherical particles resulting in a high quality end particle. Techniques applied to the preparation of a coating for a spherical surface currently involve numerous cumbersome, and often expensive, intermediate-processing steps. (Hanprasopwattana et al., Langmuir 12, 3173 (1996); Fu et al., Colloids and Surfaces A 186, 245 (2001); Holgado et al., Journal of Colloid and Interface Science 229, 6 (2000)). These steps involve multiple washings and centrifugations, and often degrade particle quality. Also, intermediate steps like sintering can profoundly affect the surface character of the particles being processed. It is therefore highly desirable to discover methods by which particles can be coated in-situ, thereby reducing the number of processing steps and retaining most of the original surface characteristics of the nanoparticles. In addition, due to the number of processing steps involved in coating nanoparticles, conventional techniques typically must be carried out in batches. Reproducibility is often a concern in batch processing, with product variation from batch to batch. Hence, it is also desirable to develop continuous processes for coating nanoparticles.

### SUMMARY OF THE INVENTION

Microchemical systems offer potential advantages both in the ability to synthesize colloids, tune their surface properties, composition and crystallinity and in the ability to control their self-assembly as a route to materials synthesis on multiple length scales. As used herein, the term “nanoparticle” encompasses particles ranging in size from as small as about one nanometer to as large as several hundred nanometers in diameter. The ability to integrate these functions into a single device gives a powerful platform for the discovery, screening and analysis of novel materials. In one embodiment, the invention relates to a microreactor and a method for synthesizing colloidal nanoparticles using the microreactor. The microreactor has at least one inlet channel; at least one micromixing block positioned downstream from the at least one inlet channel; an aging section positioned downstream from the at least one micromixing block channel where the nanoparticles can grow to their final size; and at least one outlet channel positioned downstream from said aging section.

In another embodiment, the invention relates to an apparatus and method for synthesizing colloidal nanoparticles, coating colloidial nanoparticles, or both synthesizing and coating colloidal nanoparticles using the apparatus. Components of the apparatus include at least one microreactor; and at least one electrophoretic switch. Each component of the apparatus is connected to at least one other component. In a preferred embodiment, the apparatus also includes an ultrasonication mean, such as an ultrasonication bath into which the apparatus or a portion thereof is immersed, or an ultrasonication transducer which is attached to the apparatus. Ultrasonication prevents blockage of the microchannels. The apparatus can be used to coat the synthesized colloidal particles with one or more layers of other substances. The components of the apparatus may be on one module, on more than one module or, preferably, each component of the apparatus may be on a separate module. The modules can be connected to a component on a separate module via, for example, tubing. The components of the apparatus may be connected in any desired order. For example, a first microreactor may be connected to an electrophoretic switch or to a second microreactor. In addition, the components may all be connected in series or some of the components may be connected in parallel while others are connected in series.

In one aspect, synthesis of colloidal nanoparticles of materials such as silica, titania, zirconia, ceria, ferrite, or alumina is accomplished in a microreactor. In addition, co-ordination compounds (chelates) containing metal ions may be used to generate solid particles in a microreactor. In another aspect, the microreactor fabricated in, for example poly-dimethyl siloxane, silicon, glass, or a polymer, consists of at least one micromixing block followed by an aging section where the particles grow to their final sizes. In yet another aspect, the microreactor further comprises a quench fluid inlet port downstream from the aging section so as to stop nanoparticle growth.

In-situ coating and/or purification is facilitated by an electrophoretic switch. An electrophoretic switch is an assembly of electrodes that uses electric fields to facilitate transport of the colloid particles in various directions on-chip to accomplish tasks such as separation and purification. In one embodiment, an electrophoretic switch includes a first inlet channel for introducing a first liquid stream into said electrophoretic switch, wherein the first liquid stream comprises suspended nanoparticles; a second inlet channel separate from said first inlet channel for introducing a second liquid stream into said electrophorectic switch; a switch channel downstream from said first and second inlet channels, wherein said first liquid stream and said second liquid stream are contacted at an interface; at least one negatively charged electrode on one side of the liquid interface in the switch channel; at least one positively charged electrode on the opposite side of the liquid interface in the switch channel from the at least one negatively charged electrode; and at least one exit channel downstream from said switch channel.

In one aspect of the invention, an electrophoretic switch is incorporated downstream from a microreactor for transferring the nanoparticles into another stream, such as a substantially pure fluid or another reactant. When the nanoparticles are transferred into a substantially pure fluid stream, the particles are separated and purified. Alternatively, the switch may extract synthesized nanoparticles into a coating reactant stream where the nanoparticles react with the coating reactant and thereby are coated. In a preferred embodiment, the nanoparticles are coated with a biological molecule, such as an oligonucleotide, an amino acid, peptide, carbohydrate or protein. In one embodiment, the transfer of nanoparticles from one stream to the other is accomplished by electrophoresis. In another embodiment, the electrophoretic switch of the present invention accomplishes the transfer by dielectrophoresis.

Utilizing the apparatus of the invention structures can be realized that cannot be obtained with conventional macroscale technology. For example, heat and mass transfer is expedited in the microscale apparatus of the invention such that more aggressive processing conditions that are not feasible on a macroscopic scale may be used. In addition, the size of the nanoparticle formed can be controlled by the size of the microchannels. An electrophoretic switch can be used to purify nanoparticles which eliminates the need for cumbersome wash and centrifugation steps. Finally, the apparatus of the invention enables continuous multi-step particle processing, that is extremely difficult to achieve using macroscale techniques.

### BRIEF DESCRIPTION OF THE DRAWING

The invention is described with reference to the several figures of the drawing, in which,

FIG. 1A is a schematic of one embodiment of a microreactor for synthesis of colloidal nanoparticles;

FIG. 1B is a schematic of another embodiment of a microreactor for synthesis of colloidal nanoparticles;

FIG. 2 is an illustration of one embodiment of an electrophoretic switch;

FIG. 3 is schematic of one embodiment of an apparatus having a microreactor and electrophoretic switch;

FIG. 4 is a schematic of another embodiment of a microreactor;

FIG. 5 depicts SEM micrographs of silica particles synthesized within the microreactor illustrated in FIG. 4;

FIG. 6 depicts high-resolution TEM micrographs of silica particles synthesized within the microreactor illustrated in FIG. 4; and

FIG. 7 depicts SEM micrographs of titania nanoparticles synthesized in the microreactor illustrated in FIG. 4.

### DETAILED DESCRIPTION

Colloidal Particles

A colloid is a suspension in which the dispersed phase is so small that gravitational forces are negligible and interactions are dominated by short-range forces, such as Van der Waals attraction and surface charges. The inertia of the dispersed phase is small enough that it exhibits Brownian motion, a random walk driven by momentum imparted by collisions with molecules of the suspending medium.

Meso-scale (aproximately 10 nm to approximately 10 μm) colloidal particles are highly encountered forms of materials in nature and in the physical sciences. In chemistry, typical examples include, but are not limited to, polymers, silica and gold colloids, and latex particles. In biology, typical examples include, but are not limited to, mesoscale colloids such as proteins, viruses and cells. In addition, there are many hierarchically assembled structures of these colloidal particles over multiple length scales. For example, a natural opal is iridescent in color because silica colloids (colorless by themselves) have been organized into a three-dimensionally ordered array with a lattice constant that is comparable to the wavelength of visible light (400-800 nm).

The ability to assemble colloidal nanoparticles into 2D and 3D crystalline structures is directly useful in many areas. 2D colloidal crystalline lattices can be used as arrays of micro-lenses in imaging, as physical masks for evaporation or reactive ion etching to fabricate regular arrays of micro- or nanostructures, and as maters to cast elastomeric stamps for use in micro-contact printing (Park et al., Langmuir, 15, 226 (1999)). 3D crystalline lattices can be used for diffractive elements in fabricating sensors or optical components like gratings (Weissman et al., Science, 274, 959 (1996)), filters (Park et al., Langmuir, 15, 226 (1999)), switches (Chang et al., Journal of the American Chemical Society, 116, 6739 (1994)), and photonic band gap crystals (Asher et al., MRS Bulletin, October 1998, 44 (1998) and van Blaaderen, MRS Bulletin, October 1998, 39 (1998)), as templates to fabricate porous membranes (Holland et al., Science, 281, 536 (1998)), and as precursors for high strength ceramics. Moreover, these crystalline lattices have also been used as model systems to study fundamental phenomena such as crystallization, phase transition and fracture mechanics (Crocker et al., MRS Bulletin, October 1998, 24 (1998) and Murray, MRS Bulletin, October 1998, 33 (1998)).

Chemistry

1. Sol-Gel Science

A sol is a colloidal suspension of solid particles in a liquid. In the sol-gel process, the precursors for preparation of a colloidal sol consist of a metal or metalloid element surrounded by various ligands. Metal alkoxides are the most widely used class of precursors in sol-gel research. These precursors are members of the family of metalorganic compounds, which have an organic ligand attached to a metal or metalloid atom. A thoroughly studied example is silicon tetraethoxide (or tetraethoxysilane, or tetraethyl orthosilicate, TEOS), Si(OC₂H₅)₄. Organometallic compounds are defined as having direct metal-carbon bonds, not metal-oxygen-carbon linkages as in metal alkoxides. Thus metal alkoxides are not organometallic compounds, as often referred to in the literature. A tertiary alkoxide may be represented by the formula M¹(OR)₄, wherein M¹ is Ti, Si, or Zr; and R is an alkyl group.

Metal alkoxides react readily with water. The reaction is called hydrolysis, because a hydroxyl ion becomes attached to the metal atom, as in the following reaction:
Si(OR)₄+H₂O→HO—Si(OR)₃+ROH (1)
The R represents a proton or other ligand (if R is an alkyl, then OR is an alkoxy group), and ROH is an alcohol. Depending on the amount of water and catalyst present, hydrolysis may go to completion (so that all of the OR groups are replaced by OH),
Si(OR)₄+4H₂O→Si(OH)₄+4ROH (2)
or the reaction may stop while the metal is only partially hydrolyzed, Si(OR)₄₋ₙ(OH)ₙ. Two partially hydrolyzed molecules can link together in a condensation reaction, such as
(OR)₃Si—OH+HO—Si(OR)₃→(OR)₃Si—O—Si(OR)₃+H₂O (3)
or
(OR)₃Si—OR+HO—Si(OR)₃→(OR)₃Si—O—Si(OR)₃+ROH (4)
By definition, condensation liberates a small molecule, such as water or alcohol. This type of reaction can continue to build larger and larger silicon containing molecules by the process of polymerization. According to Iler, condensation takes place in such a fashion as to maximize the number of Si—O—Si bonds and minimize the number of terminal hydroxyl groups through internal condensation. (Iler, The Chemistry of Silica (1979)). Thus rings are quickly formed to which monomers add, creating three-dimensional particles. These particles condense to the most compact state leaving OH groups on the outside.

In a preferred embodiment of the present invention, a microreactor is used to synthesize silica particles using sol gel processing. A tetra-alkyl-orthosilicate precursor, such as tetra-ethyl-orthosilicate, can be used to prepare silica nanoparticles. Similarly, in another preferred embodiment, a microreactor is used to synthesize titania particles using sol gel processing. A titanium tetra-alkyloxide precursor, such as titanium tetraethoxide or titanium tetra-(n-butoxide), can be used to prepare titania nanoparticles.

Coagulation is often a problem in conventional batch synthesis of titania. Large amounts (i.e. 10 to 50%) of agglomeration occur when reactant concentrations are above 0.1% solids. Agglomeration is caused by frequent collisions in the concentrated suspensions obtained from the concentrated reactant solutions that give high nucleation rates. In order to overcome this problem, hydroxy-propyl cellulose (HPC) has been used as a steric-stabilization agent during the precipitation. (Jean et al., Materials Research Society Symposium Proceedings, 73, 85 (1986) and Mates et al., Colloids and Surfaces, 24, 299 (1987)). Experimental results suggest that HPC molecules are reversibly adsorbed and are not incorporated during particle formation, with most of the adsorbed HPC present on the external particle surfaces. Fast adsorption-desorption compared with the powder precipitation process prevents the HPC molecules from being incorporated into the particle structure and prevents particle agglomeration throughout growth. In one aspect of the invention, the use of a microfluidic route obviates the need for stabilizers like HPC.

2. Alumina Sol-Gel (or Alumoxane)

Aluminum hydroxide gels may be prepared from the hydrolysis of aluminum alkoxides, Al(OSiR₃)₃ via the following reaction: 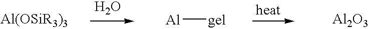
(see Chem. Mater. (1992), 4:167, the entire teachings of which are incorporated herein by reference.) The surface of the aluminum oxide sol-gel may be modified with an anionic ligand, such as a carboxylate anion (see J Mater. Chem. (1995), 5:331 and Chem. Mater. (1997), 9:2418, the entire teachings of each of the foregoing references are incorporated herein by reference in their entirety.)

3. Ceria (CeO₂) Nanoparticles

Ceria nanoparticles can be prepared by mixing equal volumes of solutions of 0.0375 M Ce(NO₃)₃ and 0.5 M hexamethylenetetramine at room temperature. (See Zhang, et al., Applied Physics Letters (2000), 80:127, the entire teachings of which are incorporated herein by reference.)

4. Co-Ordination Compounds

Co-ordination compounds can be used to synthesize nanoparticle oxides of La, Sr, Mn, Fe, Co, Ce, Gd, Cu, or Ni. The co-ordination compounds are formed by dissolving one mole of a hydrated oxide, alkoxide or an alpha-hydroxycarboxylate of titanium, zirconium or niobium with about 2 to about 8 moles of citric acid and an excess of a polyhydroxy alcohol. About 0.5 to about 1.5 equivalents of at least one basic metal (e.g., La, Sr, Mn, Fe, Co, Ce, Gd, Cu, or Ni) oxide, hydroxide, carbonate or alkoxide is added to the solution. In one embodiment, the basic metal compound may be represented by the following structural formula: 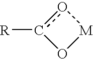
wherein M is La, Sr, Mn, Fe, Co, Ce, Gd, Cu, or Ni; and R is an alkyl, aryl or arylalkyl group. Removal of the solvent by heating, followed by calcinations of the resin to remove the organic constituents leads to an oxide, or a mixture of oxides, of La, Sr, Mn, Fe, Co, Ce, Gd, Cu, or Ni. This method is described in detail in U.S. Pat. No. 3,330,697, the entire teachings of which are incorporated herein by reference.

The term “alkyl,” as used herein, means a straight chained or banched C₁-C₂₀ hydrocarbon or a cyclic C₃-C₂₀ hydrocarbon that is completely saturated.

The term “aryl,” as used herein, either alone or as part of another moiety (e.g., arylalkyl), refers to carbocyclic aromatic groups such as phenyl. Aryl groups also include fused polycyclic aromatic ring systems in which a carbocyclic aromatic ring is fused to another carbocyclic aromatic ring (e.g., 1-naphthyl, 2-naphthyl, 1-anthracyl, 2-anthracyl, etc.) or in which a carbocylic aromatic ring is fused to one or more carbocyclic non-aromatic rings (e.g., tetrahydronaphthylene, indan, etc.). The point of attachment of an aryl to a molecule may be on either the aromatic or non-aromatic ring.

An arylalkyl group, as used herein, refers to an aryl group that is attached to an other moiety via an alkylene linker.

An alkylene refers to an alkyl group that has at least two points of attachment to at least two moieties (e.g., methylene, ethylene, isopropylene, etc.).

Microreactors

Microreactors are tools for carrying out chemical reactions, and have certain critical features in the micron size range. This technology represents a radical departure from conventional chemical reactors, either in the laboratory or in industry, wherein the typical feature sizes range from a few centimeters to several meters. Microchemical systems are integrated structures that enable chemical reactions, species separation and continuous monitoring of processing conditions.

Small length scales realize structures with capabilities that exceed conventional macroscopic systems. These enhanced capabilities manifest themselves in the enhancement of the physical transport phenomena underlying all chemical processes, and the ability to control and tune them. The inherently small length scales (and hence high surface-to-volume ratios) involved expedite heat and mass transfer to such an extent that aggressive processing conditions not feasible on a macroscopic scale are realizable in microreactors.

In one preferred embodiment of the invention, synthesis of colloidal nanoparticles is accomplished in a microreactor. An microreactor for synthesizing colloidal nanoparticles includes at least one inlet channel; an aging section positioned downstream from said at least one micromixing block channel; and at least one outlet channel positioned downstream from said aging section. Optionally the microreactor may also include at least one micromixing block positioned downstream from said at least one inlet channel. In one aspect, the microreactor design allows very little lateral movement of the growing particles in the microreactor, and the particles follow the streamlines of fluid flow. In another aspect, the reactions taking place inside the microreactor are liquid-liquid reactions giving solid products. Other aspects include solid-liquid reactions where reactants from the liquid phase react with solid surfaces, thus causing coating.

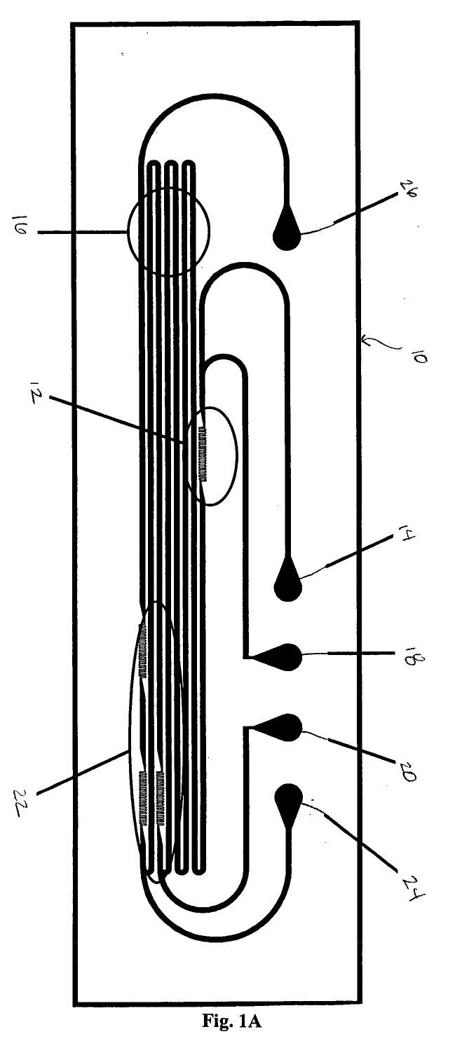

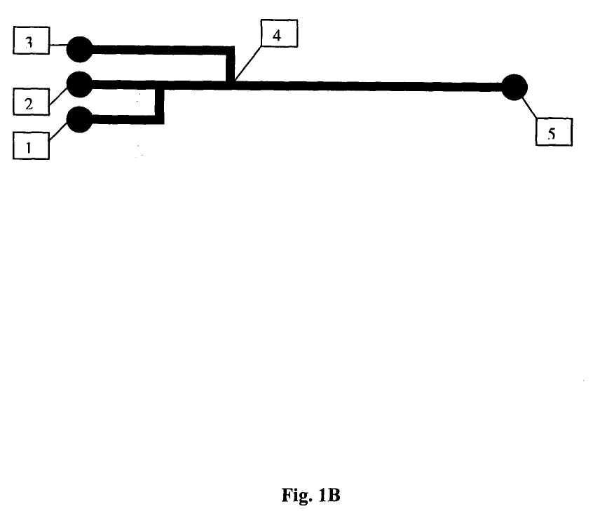

In a preferred embodiment of the present invention, synthesis of colloidal particles is accomplished in a microreactor 10 depicted in FIG. 1A. The microreactor in FIG. 1A has inlets 14, 18 and 20 for introducing reactants into the microreactor. Inlets 14 and 18 are followed by micromixing block 12 which is followed by aging channel 16 that provides aging length for the growing nanoparticles. The micromixing section 12 is a very thin and long channel in which complete mixing by diffusion occurs in approximately less than one second. In addition, the mixing block can have posts staggered throughout the flow path to enhance mixing of the reactants. In one aspect, inlet channels 14, 18, 20 are approximately 10-5000 μm wide and 10-2000 μm deep, while the aging channels 16 are approximately 10-5000 μm wide, 10-2000 μm deep, and 1 mm-1 m in length. The length of the aging channel is determined by the desired size of the nanoparticles. In general, the larger the nanoparticles desired, the longer the aging channel. Preferably, the length of the aging channel is in the range of between about 1 mm and about 100 cm. Flow rates used are approximately 0.1-10 μL/min. In another aspect, the micromixing sections 12, 22 are approximately 1-200 μm wide and 10-2000 μm deep. In another embodiment, the microreactor 10 has an inlet 24 for quench fluid introduced to stop the aging process of the particles. The quench fluid is introduced at a flow rate of greater than or equal to the flow rate of the reacting fluids. In a preferred embodiment, the quench fluid is introduced at a flow rate of 3 to 4 times greater than the flow rate of the reacting fluids. Typically, the quenching fluid is introduced to stop the growth of the nanoparticles. In one aspect, the quench fluid is an inert liquid, such as alcohol. Finally, the microreactor 10 has at least one outlet or exit channel 26 in which the final product of synthesized nanoparticles may exit the device 10. The exit channel 26 is approximately 10-5000 μm wide and 10-2000 μm deep.

Depending on the reaction used to form the nanoparticles, the kinetics of growth of the particles is governed by various physical phenomena. For example, the rate at which particles grow can be governed by the rate of the chemical reaction occurring at the surface of the growing particle. Alternatively, it may be governed by the rate of transport of the reacting species from the bulk liquid to the surface of the growing particle. In either cases, the final size of a particle depends on the amount of time it spends in the reactor. Microfluidic flow in the microreactors of the invention is laminar, and hence has a parabolic velocity profile. This means that regions of fluid at the center of a flow-channel flow faster than those near the walls. Hence, there exists a distribution of residence times of the growing colloidal particles in the reactor. Depending on the interaction between the mechanism of growth (i.e. growth kinetics) and this residence time distribution (RTD), one can have different situations where perfectly monodisperse particles may be obtained (self-sharpening size distributions) or polydisperse particles may be obtained. The advantage of working with microreactors lies in the fact that fluid flows are analytically tractable. Hence if the mechanism of growth is known, it can be coupled with the RTD to predict (to a good degree of accuracy) the particle size-distributions. Methods form using chemical reaction kinetics and RTD to predict particle size distribution can be found in Fogler, H. S. (1992), Elements of Chemical Reaction Engineering, 2^{nd} Edition, Prentice-Hall Inc, New Jersey; Levenspiel, 0. (1972), Chemical Reaction Engineering, John Wiley and Sons, New York; and Froment, G. F. and Bischoff, K. B. (1990), Chemical Reactor Analysis and Design, 2^{nd} Edition, John Wiley and Sons, New York, the entire teachings of each of the foregoing references is incorporated herein.

In another preferred embodiment of the present invention, synthesis of colloidal particles is accomplished in a segmented-flow microreactor depicted in the FIG. 1B. Segmented flow is a two-phase flow that consists of alternating slugs of two different immiscible fluids or alternating slugs of a gas and a liquid. In one embodiment, reactants enter the microreactor through inlets 1 and 2. The reactants meet at mixing block 4, where a gas or immiscible liquid that enters the reactor through inlet 3 is used to segregate slugs containing both reactants 1 and 2. These segregated slugs flow through the reactor, while reactants 1 and 2 mix within the slug, and each slug forms a “batch” of nanoparticles. The reaction takes place in aging channel 6 and product is collected at outlet 5. All channels have a depth in the range of between about 10 μm and about 2000 μm, and a width in the range of between about 10 μm and about 5000 μm. This embodiment is one possible way to reduce the effects of laminar-flow residence time distribution on the particle size distribution.

Clogging of microchannels due to the accumulation of particles at dead-ends or stagnant zones is a commonly encountered problem when running fast particle synthesis reactions like the synthesis of titania nanoparticles. One method of overcoming this problem is to design the microreactor or an apparatus containing one or more microreactor and/or one or more electrophoretic switch to have the minimum amount of stagnant zones. Another method of overcoming this problem is by using ultrasound. The microreactor or apparatus, or a portion thereof, may be introduced into a medium that is being sonicated (like an ultrasonic bath). Alternatively, a small ultrasonic transducer that transmits ultrasonic waves may be attached to the microreactor or apparatus itself.

Preferably, the microreactor or apparatus are designed to have as few stagnant zones as possible and are also sonicated using an ultrasonic bath or an ultrasonic transducer. No clogging is observed when the reaction is carried out in such a manner.

Microfabrication

Microreaction technology has rapidly advanced in the last few years, spurred on by concurrent advances in microfabrication and micro-electro-mechanical systems (MEMS) technology, and has been applied to a broad range of processes and chemistries. The potential of microchemical synthesis has been demonstrated for various single and multi-phase chemistries, as reviewed by Jensen and Ehrfeld. (Jensen, Chemical Engineering Science, 56, 293 (2001) and Ehrfeld, et al., Microreactors: New Technology for Modern Chemistry (2000). The principle techniques of fabrication have been: MEMS based bulk machining and deep reactive ion etching (DRIE) coupled with various bonding approaches, lithography, electroplating and molding in metal (LIGA), microelectrodischarge machining (μEDM), polymer microinjection molding and embossing, and the collection of techniques under the common title of ‘soft lithography’.

The class of microfabrication techniques called ‘soft lithography’ provides a flexible, rapid prototyping method for screening microfluidic devices that have been developed for realizing new processes. (Xia et al., Angewidante Chemie (International Edition), 37, 551 (1998) and Xia et al., Annual Review of Materials Science, 28, 153 (1998)). The main advantages of soft lithography are the ability to transfer patterns onto nonplanar surfaces, compatibility with polymers, metals and ceramics and, above all, very small turnover times between conceptualization and experimentation. These advantages are important requirements when working with processing techniques that have no macroscopic equivalent, and hence require several iterations before the device design is optimized.

Soft lithography involves the use of transparent elastomer-based pattern transfer elements (usually PDMS—polydimethyl siloxane), having patterns embossed on their surfaces. Although suitable for aqueous systems, PDMS swells in organic solvents and has limited temperature stability. This restricts its use to biological applications, micromixers and electrophoretic devices. Different embodiments of the present invention employ combinations of various soft-lithography based techniques to realize the microfluidic structures of the invention.

In one aspect, the devices of this invention are fabricated in PDMS. In this aspect, the process consists, for example, of the following steps:
1. Preparing a master on silicon, which can be used to transfer the pattern to the PDMS elastomer. This may be achieved by spin-coating a thin 50 μm layer of negative photoresist, such as SU-8(50) available from MicroChem Corp., onto a 4″ silicon wafer and patterning it using standard photolithographic techniques. In other embodiments of the invention, preparing a master on silicon may be achieved by spin-coating an approximately 10-2000 μm layer of negative photoresist onto a silicon wafter.
2. Moulding the PDMS onto this pattern, and curing it at approximately 70° C. for approximately 2 hours. In other embodiments of the invention, curing times may be from approximately 2-24 hours.
3. Sealing the devices using another slab of PDMS, by ashing both the surfaces to be sealed in an O₂ plasma.
4. Packaging the devices by gluing PEEK tubing to the inlet and outlet ports.

In other aspects, fabrication of the devices may also be accomplished by other techniques, including but not limited to: laser micromachining of plastics like polymethyl-methacrylate (PMMA), silicon microfabrication techniques like deep reactive ion-etching (DRIE), micro-milling on plastics, microelectrodischarge machining of metals, and lamination of patterned ceramic layers.

In another aspect, the devices of this invention are fabricated in silicon. A typical process consists, for example, of the following steps:
1. Photolithography and patterning of channel features onto the frontside of a 6″ silicon wafer using a thick photoresist.
2. Deep reactive ion etching of features to the desired depths.
3. Photolithography and patterning of inlet holes on the backside of the wafer.
4. Deep reactive ion etching of features to the desired depths on the wafer backside.

In another aspect, the devices may be fabricated by laser micromachining of plastics or glass. A typical process consists of, for example, the following steps:
1. Reading of the pattern to be transferred onto the substrate into laser.
2. Laser ablation of the substrate to the desired depths, producing microchannels.

In another aspect, the devices may be fabricated in glass, by using wet etching techniques. The etchant, for example, may be hydrofluoric acid.

In yet another aspect, the devices may be fabricated by reaction-injection molding, a common process used to make large quantities of minute plastic parts. A typical process consists of, for example, the following steps:
a. Fabricate metal master.
b. Mould plastic on master by injection molding.
   Coating Colloidal Particles—Generally

Materials are coated for a number of reasons. For example, materials may be coated to make a substance biocompatible, increase a material's thermal, mechanical or chemical stability, increase catalytic activity, increase wear protection, durability or lifetime, decrease friction or inhibit corrosion, alter the refractive index and optical properties, or change the overall physiochemical and biological properties of the material.

There are numerous coating procedures that are widely used in research and industrially, however these are generally suitable for planar substrates. For materials on a sub-micron scale, solution-based processes like sol-gel chemistry are more attractive. Coating nanometer-scale colloids with other layers of substances on smaller length scales results in nanocomposites that have enhanced properties and/or new emergent functionalities.

Colloidal particles are often coated to alter the surface properties, such as adding a specific charge or functionality, thereby changing or having an influence on their stability. Such coatings can widen the areas of application of particles in certain areas.

The term ‘particle engineering’ describes synthesis of core-shell particles with defined morphologies and properties. This typically involves tailoring the surface properties of particles, often accomplished by coating or encapsulating them within a shell of a preferred material. Caruso has reviewed the extensive literature on sol-gel nanocoating techniques of colloidal particles to create core-shell type materials. (Caruso et al., Chemistry of Materials, 13, 3272 (2001), the entire teachings of which are incorporated by reference).

Titania-coated silica spheres have potential use in catalytic, pigment, and photonic crystal applications. Silica microspheres have been coated with titania monolayers using titanium tetra-butoxide in THF under nitrogen and with multilayers using titanium n-butoxide in ethanol. (Srinivasan et al., Journal of Catalysis, 131, 261 (1991); Srinivasan et al., Journal of Catalysis, 145, 565 (1994); and Hanprasopwattana et al., Langmuir, 12, 3173 (1996), the entire teachings of each of the forgoing references are incorporated by reference). Coating thicknesses of sub-monolayer to 7 nm of amorphous titania were achieved; upon calcination, polycrystalline anatase coatings were found. Control of precursor and water concentrations was essential for preventing precipitation of titania particles and aggregation of the coated particles. Developing this process to a multi-step method on larger monodisperse spheres gave a coating thickness of 46 nm after five repeated deposition steps. (Guo et al., Langmuir, 15, 5535 (1999); Fu et al., Colloids and Surfaces A: Physiological and Engineering Aspects, 186, 245 (2001); and Holgado et al., Journal of Colloid and Interface Science, 229, 6 (2000), the entire teachings of each of the forgoing references are incorporated by reference). These methodologies all employ a macroscopic batch technique with a number of intermediate processing steps. A preferred embodiment of the present invention utilizes continuous microfluidic techniques, as opposed to a macroscopic batch technique, and therefore eliminates the number of intermediate processing steps inherent in the macro-methods.

There has been much research concerning the immobilization of proteins onto solid supports, mainly because of the importance of proteins in biotechnology. (Caruso, Advanced Materials, 13, 11 (2001), the entire teachings of which are incorporated by reference). The potential applications of colloidal particles with attached biological molecules (e.g., amino acids, peptides, proteins such as enzymes or antibodies, antigens, oligonucleotides, carbohydrates and the like) have long been recognized. Particles that have biomolecules coupled to their surface can specifically react with antigens, target cells or viruses and can be used for in-vitro or in-vivo applications. Application areas of these immuno-particles are diverse, ranging from immunoassays, bio-separations and hybridization assays through to biochemical or enzymatic reactions, affinity chromatography, clinical analysis and diagnostics. A variety of techniques are used for the immobilization of biomacromolecules: passive adsorption, covalent bonding, sol-gel entrapment, specific recognition, and electrostatic self-assembly methods.

The term “nucleic acids,” or “oligonucleotides,” as used herein, refers to a polymer of nucleotides. The polymer may include natural nucleosides (i.e., adenosine, thymidine, guanosine, cytidine, uridine, deoxyadenosine, deoxythymidine, deoxyguanosine, and deoxycytidine) or modified nucleosides. Examples of modified nucleotides include base modified nucleoside (e.g., aracytidine, inosine, isoguanosine, nebularine, pseudouridine, 2,6-diaminopurine, 2-aminopurine, 2-thiothymidine, 3-deaza-5-azacytidine, 2′-deoxyuridine, 3-nitorpyrrole, 4-methylindole, 4-thiouridine, 4-thiothymidine, 2-aminoadenosine, 2-thiothymidine, 2-thiouridine, 5-bromocytidine, 5-iodouridine, inosine, 6-azauridine, 6-chloropurine, 7-deazaadenosine, 7-deazaguanosine, 8-azaadenosine, 8-azidoadenosine, benzimidazole, M1-methyladenosine, pyrrolo-pyrimidine, 2-amino-6-chloropurine, 3-methyl adenosine, 5-propynylcytidine, 5-propynyluridine, 5-bromouridine, 5-fluorouridine, 5-methylcytidine, 7-deazaadenosine, 7-deazaguanosine, 8-oxoadenosine, 8-oxoguanosine, O(6)-methylguanine, and 2-thiocytidine), chemically or biologically modified bases (e.g., methylated bases), modified sugars (e.g., 2′-fluororibose, 2′-aminoribose, 2′-azidoribose, 2′-O-methylribose, L-enantiomeric nucleosides arabinose, and hexose), modified phosphate groups (e.g., phosphorothioates and 5′-N-phosphoramidite linkages), and combinations thereof. Natural and modified nucleotide monomers for the chemical synthesis of nucleic acids are readily available (e.g. see, www.trilinkbiotech.com, www.appliedbiosystems.com, www.biogenex.com or www.syngendna.com). Oligonucleotides may be any length desired, but preferably have a length in the range of between 1 base to about 10,000 bases. More preferably, the length of the oligonucleotide is in the range of between 1 base and about 100 bases. Oligonucleotides may be single stranded or multistranded. For example, oligonucleotides may be single stranded, double stranded, or triple stranded.

Oligonucleotides may be attached to a solid surface, such as the surface of a nanoparticle, by methods known to those skilled in the art. For example, the oligonucleotide may be modified to include one or more 5′-thiol group which is then reacted with mercaptosilane. The product of this reaction binds to the surface of silica nanoparticles. This method is described in greater detail in Kumar, et al., Nucleic Acids Research (2000), 28 (14), page i, the entire teachings of which are incorporated herein by reference.

In another embodiment, double stranded DNA may be selectively absorbed onto the surface of silica nanoparticles in the presence of protein, lipid, carbohydrate and RNA impurities. In this embodiment, the binding reaction is carried out in a solution of a chaotropic salt, such as a 4 M sodium iodide solution that is buffered at about pH 7.5 to about pH 8. This method is described in greater detail in Melzak, et al, J of Colloid and Interface Science (1996), 181:635, the entire teachings of which are incorporated herein by reference.

An “amino acid” is compound represented by the formula NR₁H—CHR₂COOH, wherein R₁ is H and R₂ is H, an aliphatic group, a substituted aliphatic group, an aryl group, a substituted aryl group, a heteroaryl group or a substituted heteroaryl group; or R₁ and R₂, together form a akylene connecting the amine group to the α-carbon (e.g., as in proline). An amino acid can react with other amino acids to form a peptide. Amino acid residues that form a peptide have the formula —NR₁—CHR₂COO— except for the amine terminal residue which has the formula NR₁H—CHR₂COO— and the carboxylic acid terminal residue which has the formula —NR₁ —CHR₂COOH. A “naturally-occurring amino acid” is an amino acid found in nature. Examples include glycine, alanine, valine, leucine, isoleucine, aspartic acid, glutamic acid, serine, threonine, glutamine, asparagine, arginine, lysine, ornithine, proline, hydroxyproline, phenylalanine, tyrosine, tryptophan, cysteine, methionine and histidine. Methods of binding amino acids and peptides to particle surfaces may be found in Aslam, M. and Dent, A. H. (eds.), “Bioconjugation: Protein Coupling Techniques for the Biomedical Sciences,” MacMillan (1998), the entire teachings of which are incorporated herein by reference.

Separating Colloidal Particles—Electrophoresis

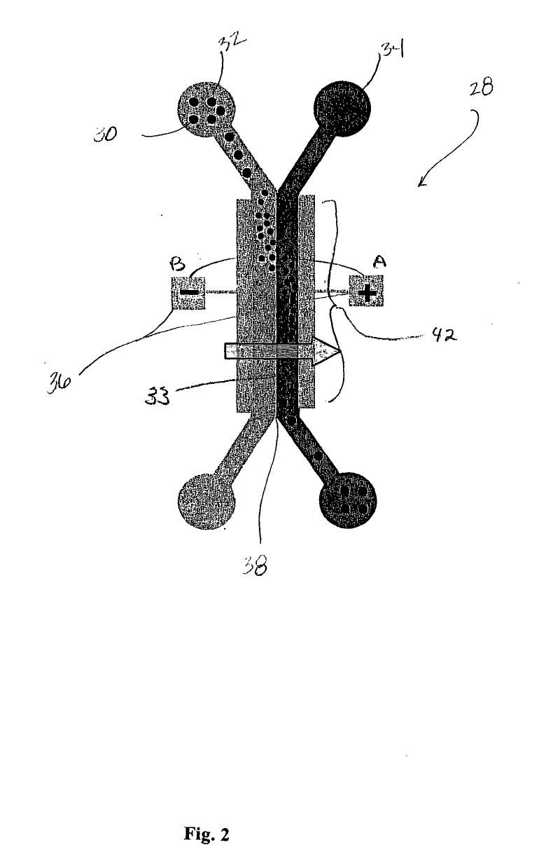

In the preferred embodiment of the present invention, microfluidic devices for the online coating of synthesized particles use the inherent surface charge on the particles to transport them across reactant streams. FIG. 2 illustrates this concept of an ‘electrophoretic switch’ 28. The term ‘electrophoresis’ is used to describe the motion of particles caused by electrophoretic polarization effects. In one embodiment, an electrophoretic switch 28 is a contacting and/or separating device that enables coating and/or purification reactions to take place in situ on the same chip. In one aspect, the switch 28 may extracts the synthesized particles 30 out of the reactant stream 32 and into a switch fluid, such as a second solvent stream 34, accomplishing separation and/or purification. Alternatively, the switch fluid 34 into which the synthesized particles 30 are extracted is a coating reactant stream (not shown).

In one aspect, the stream 32 containing synthesized particles 30 and residual reactant is brought into contact with another stream 34 containing solvent to form an interface. The area where the two solvents form the interface 33 is switch channel 42.

Because of the small width of the switch channel 42, the liquids do not have time to mix before separating as they exit the switch channel even though the solvents may be miscible. At least one positive electrode 36A is placed on one side of the interface formed in the switch channel and at least one negative electrode 36B is placed on the opposite side of the interface as positive electrode 36A. An electric field is applied between the electrodes 36, leading to electrophoretic migration of the particles into the solvent stream 34. In one embodiment, the electrodes can be made of gold, platinum, copper, nickel, silver, palladium, indium-tin oxide, and combinations thereof. In another aspect, the potential applied to the electrodes can be manipulated, thereby transporting the colloidal particles 30 from the first stream 32 to the solvent stream 34. The two streams 32, 34 are then separated at an exit of the device 38. In one embodiment, exiting stream 32 is waste while exiting stream 34 contains nanoparticles which have been separated from unwanted impurities.

Typically, the width of the switch channel is in the range of between about 1 μm and about 5 mm, the depth of the switch channel is in the range of between about 10 μm and about 2000 μm, and the length of the switch channel is in the range of between about 1 mm and about 1 m. The flow rate of the to liquids in the switch channel is in the range of between about 1 μL/min and about 100 μL/min.

In one embodiment, the nanoparticles are charged and they are moved from one fluid stream to the other fluid stream in the switch channel via electrophoretic migration in the electric field gradient produced by the electrodes.

In another embodiment, the nanoparticles moved from one fluid stream to the other fluid stream in the switch channel via dielectrophoresis. Dielectrophoresis is typically used when the nanoparticles have no inherent charge. The term ‘dielectrophoresis’ is used to describe the motion of particles caused by dielectric polarization effects in a non-uniform potential field.

In another embodiment, the invention relates to an apparatus for synthesizing colloidal nanoparticles, coating colloidial nanoparticles, or both synthesizing and coating colloidal nanoparticles. The apparatus includes at least the following components: one microreactor; and at least one electrophoretic switch, wherein each component is connected to at least one other component. All of the components may be on one module, each component may be on a separate module, or a module may contain more than one components and be connected to one or more other modules that contain one or more components. The apparatus may further include an ultrasonication means, such as a ultrasonication bath into which the apparatus or a portion thereof may be immersed, or an ultrasonication transducer which may be attached to one or more modules of the apparatus.

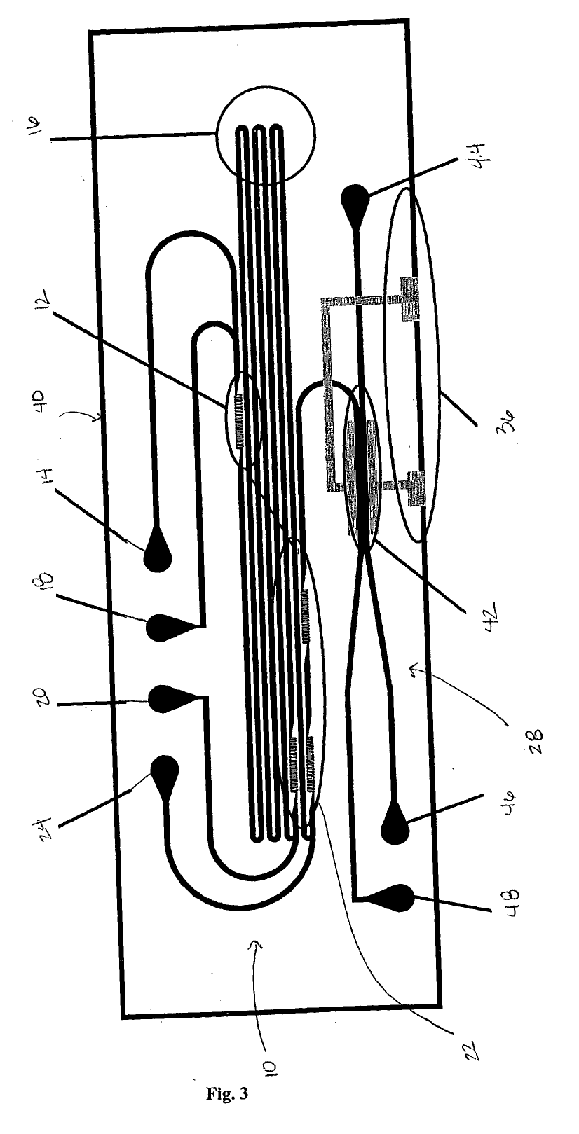

FIG. 3 depicts one embodiment of an apparatus 40 of the invention. In this embodiment, a microreactor 10 is followed by at least one electrophoretic switch 28, thereby synthesizing and enabling coating of the nanoparticles in situ. For example, a first reactant enters through a first inlet port 14. A second reactant enters through a second inlet port 18. These reactants mix in a micromixing section 12 which consists of a long, narrow and serpentine channel. Particle growth takes place in the aging channels 16 that immediately follow the first micromixing section 12. A third inlet port 20 may be provided to enable another reactant (same or different) to be added to the growing particles. In order to stop the reaction from proceeding further (e.g. after the reaction mixture exits the reactor), a quench fluid inlet port 24 is provided. The quench fluid could be an inert solvent like alcohol, and is introduced into the reactor at a flow rate equal to or greater than the reacting fluids so that effective quenching occurs. Introducing such a large amount of inert fluid into the reactor 10 at the exit basically “freezes” the reaction, and the particles do not grow further. The quenched reaction mixture then enters the switch channel 42 of the electrophoretic switch and flows parallel to a switch fluid stream (not shown) introduced through another inlet port 44. The switch fluid (not shown) can be an inert solvent like, but not limited to, alcohol, or a reactant steam (containing another alkoxide, for example). A voltage is applied across the switch channel 42 through the parallel electrodes 36 and the particles move from the reaction stream into the switch stream. Typical ranges of flow rates in the switch channel 42 are, but are not limited to, approximately 1-100 μL/min and applied voltages are typically, but are not limited to, approximately 0.1-120 V DC. Finally, the two streams in the switch channel 42 exit through exit ports 46, 48.

In another preferred embodiment of the present invention, the microreactor and electrophoretic switch are on different chips and not integrated monolithically onto one composite device as described above. This modular approach provides considerable operational flexibility, in that if one component is malfunctional, it can simply be replaced by another one of the same type. In a non-modular device, if one component were malfunctional, the whole device would have to be replaced.

In another embodiment, the apparatus includes one microreactor, comprising an aging channel; and two electrophoretic switches. In this embodiment, the first electrophoretic switch is upstream from the microreactor and the second electrophoretic switch is down stream from the microreactor. Nanoparticles can be extracted into a coating solution in the first electrophoretic switch and allowed to react with the coating reactant in the aging channel of the microreactor. The nanoparticles can then be extracted into a purification solvent in the second electrophoretic switch, thereby separating the nanoparticles from unwanted impurities. The term “purification solvent,” as used herein, refers to a solvent that is substantially free of unwanted impurities.

Exemplification

Conventional nanoparticle synthesis and processing techniques have been reviewed and critiqued and issues and areas where microfluidics offers potential benefits over conventional methods have been identified. As enumerated in the previous sections, these include but are not limited to improved particle morphologies, size distributions, modes of reactant contacting, ability to coat functionalities, control and reproducibility of these parameters and the ability to integrate multiple processing steps onto one device.

The present invention employed solution based sol-gel chemistry as the focus of the exemplification as it is one of the most widely used techniques for synthesis and processing of nanometer-scale colloidal solids. However the present invention is not limited to solution based sol-gel chemistry. Other colloids that could be synthesized in similar fashion would be Alumina (Al₂O₃), Ceria (CeₓO_{y}), Ferrite (Fe₃O₄), Zirconia (ZrO₂), and all mixtures thereof.

The present invention envisions microfluidic devices that accomplish the objectives in radically different ways than the current art, and develops design rationales for these devices.

Microreactor Design and Fabrication

The following algorithm dictated the reactor design:
1. Conducted lab-scale experiments with stirred batch and semi-batch reactors (as described in the previous sections).
2. Identified from these experiments key parameters for design: optimal stoichiometries, micromixing, shear effects, batch times, solution turbidity etc.
3. Converted batch data in terms of reaction time to reaction length for continuous flow microreactors, which are essentially laminar-flow tubular reactors with axial dispersion.
4. Identified potential microfabrication issues and arrive at final design.
5. Tested the fabricated reactor and redesign, if necessary.

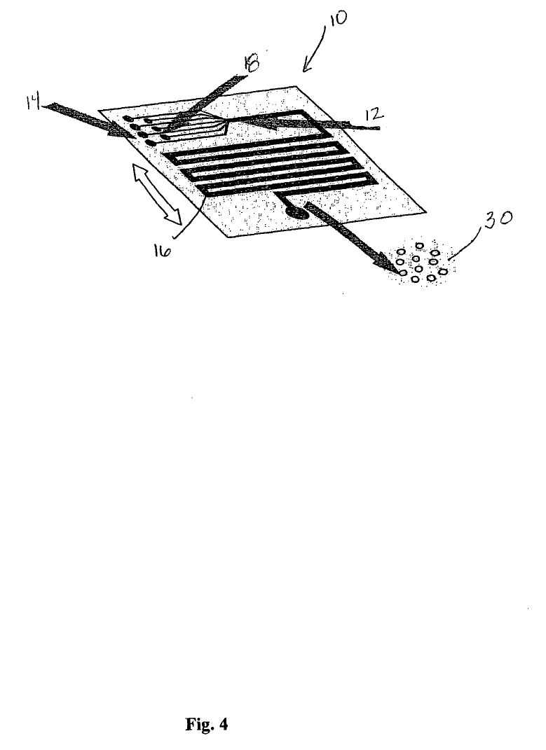

An initial microreactor design is shown in FIG. 4. This initial microreactor was used in the experiments herein. Microfabrication was carried out via soft lithography techniques as described earlier. The devices were fabricated in PDMS. The process consisted of the following steps:
5. Prepared a master on silicon, which was used to transfer the pattern to the PDMS elastomer. This was done by spin-coating a thin 50 μm layer of negative photoresist [SU-8(50)] onto a 4″ silicon wafer and patterning it using standard photolithographic techniques.
6. Moulded the PDMS onto this pattern, and cured it at 70° C. for 2 hours.
7. Sealed the devices using another slab of PDMS, by ashing both the surfaces to be sealed in an O₂ plasma.
8. Packaged the devices by gluing PEEK tubing to the inlet and outlet ports.
   A micromixing section 12 was located at an inlet 14, followed by channels 16 that provided aging length for the growing particles 30. At least one inlet channel 14 was 50 μm wide, while the aging channels 16 were 400 μm wide. The total length of the reactor 10 was 90 cm, and the flow rates used were 5-20 μL/min, which correspond to linear velocities of 4.2-16.8 mm/sec. The reactants (not shown) were introduced into the reactor 10 using a syringe pump (not shown), and were collected in a glass vial (not shown) for further analysis.
   Microreactor Operation and Analysis

In operation, silica and titania were synthesized via sol gel processing using a microreactor 10 of FIG. 4. For silica, equal flow rates of two reactant streams were injected into the reactor 10 at an inlet 14. The total flow rate used was 6 μL/min, corresponding to a residence time of 3 minutes in the microreactor 10. A typical reactor 10 involves a stream of 0.2M TEOS meeting a stream containing 2.0M NH₃ and 30.0M H₂O in the inlet micromixer section 12.

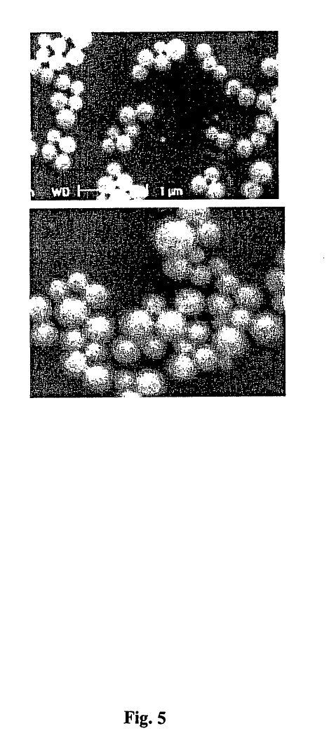

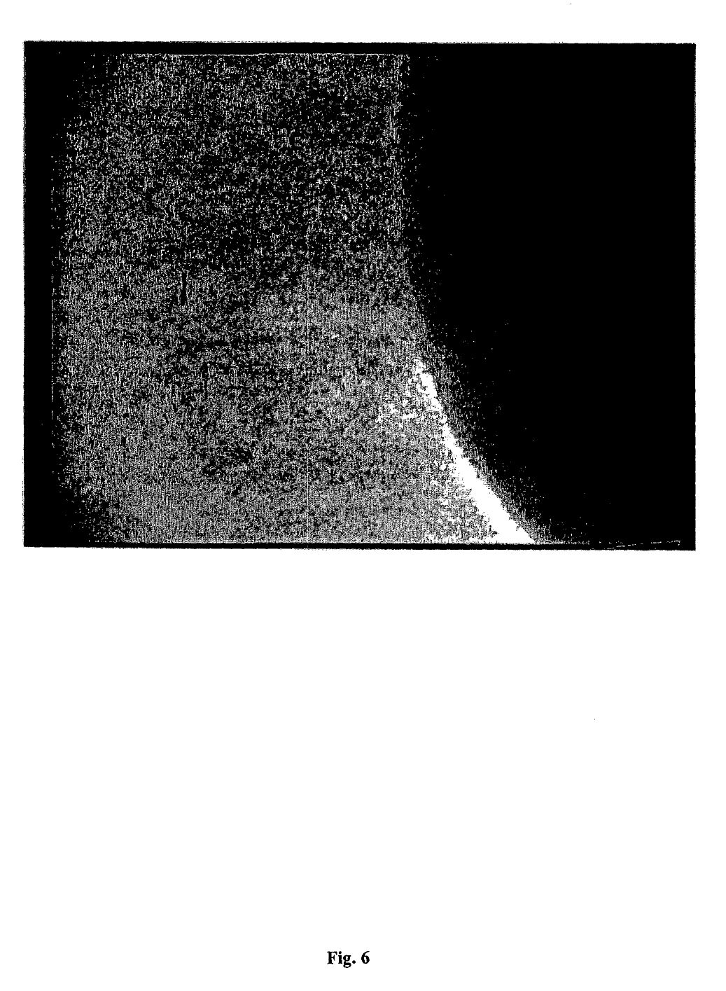

FIG. 5 depicts an SEM micrograph of the thus synthesized particles. The particles are unagglomerated and have mean diameter of 200 nm. Polydispersity was observed. High-resolution TEM micrographs in FIG. 6 indicated extremely smooth (at the nanometer-level) particle surfaces of the silica particles from the experimental microreactor 10.

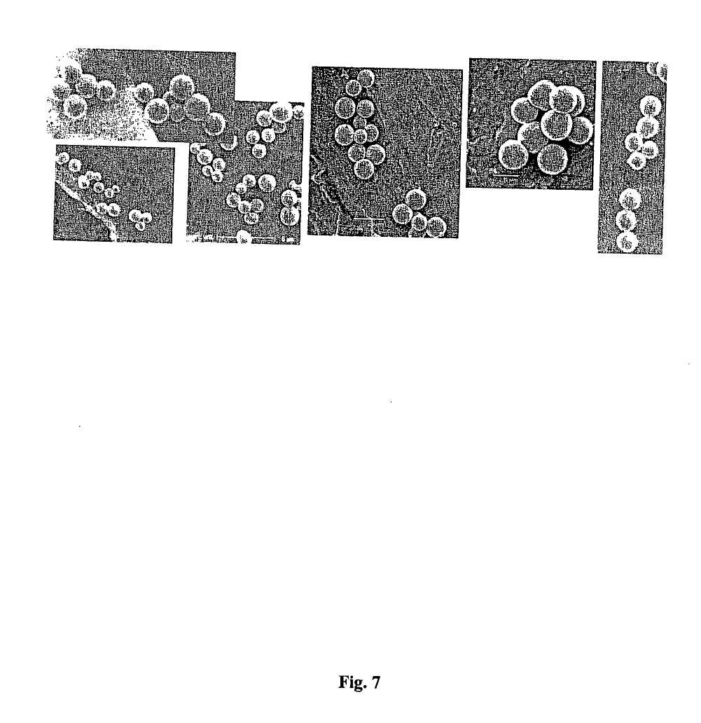

Titania synthesis was carried out using a similar procedure. A total flow-rate used was 20 μL/min, corresponding to a residence time of approximately 1 minute. A solution of titanium tetraethoxide (0.15M) was injected into the reactor along with another stream comprising of a 0.5M solution of water in ethanol. FIG. 7 shows the results obtained from the microreactor 10. Uniform, unagglomerated spheres were obtained, with individual particles growing to sizes exceeding 1 m. The particles had extremely smooth surfaces. Such results can usually be obtained conventionally only if anti-coagulants like hydroxy-propyl cellulose (HPC) are added to the reacting mixture to provide steric stabilization.

Electrophoretic Switch Design and Operation

A stream 32 of silica particles 30, as synthesized from the experimental microreactor 10 was introduced into an electrophoretic switch 28 at a flow rate of 50 μL/min (as shown in FIG. 2 and FIG. 3). A stream of pure alcohol 34 at the same flow rate was introduced into an inlet port 44 of the electrophoretic switch 28. A voltage of 100V DC was then applied across the two parallel electrodes 36. Colloidal silica 30 was seen to migrate into the pure alcohol solvent stream 34, accomplishing separation and purification.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1. An microreactor for synthesizing colloidal nanoparticles comprising:
at least one inlet channel;
at least one micromixing block positioned downstream from said at least one inlet channel;
an aging section positioned downstream from said at least one micromixing block channel; and
at least one outlet channel positioned downstream from said aging section.

2. The microreactor of claim 1, further comprising an ultrasonication means.

3. The microreactor of claim 2, wherein the ultrasonication means is an ultrasonication bath into which the microreactor or a portion thereof is emersed.

4. The microreactor of claim 2, wherein the ultrasonification means is an ultrasonification transducer that is attached to the microreactor.

5. The microreactor of claim 1 wherein the width of said at least one inlet channel is in the range of between about 10 μm and about 5000 μm.

6. The microreactor of claim 1 wherein the depth of said at least one inlet channel is in the range of between about 10 μm and about 2000 μm.

7. The microreactor of claim 1 wherein said aging section comprises at least one aging channel.

8. The microreactor of claim 7 wherein the length of said at least one aging channel is in the range of between about 1 mm and about 100 cm.

9. The microreactor of claim 7 wherein the width of said at least one aging channel is in the range of between about 10 μm and about 5000 μm.

10. The microreactor of claim 7 wherein the depth of said at least one aging channel is in the range of between about 10 μm and about 2000 μm.

11. The microreactor of claim 1 wherein a first reactant stream is introduced into said microreactor at a first inlet channel.

12. The microreactor of claim 11 wherein a second reactant stream is introduced into said microreactor at a second inlet channel.

13. The microreactor of claim 12 wherein a third reactant stream is introduced into said microreactor at a third inlet channel.

14. The microreactor of claim 1 wherein more than one reactant stream are introduced into said microreactor through one inlet channel.

15. The microreactor of claim 1 wherein said microreactor employs solution-based sol-gel processing.

16. The microreactor of claim 15 wherein a first reactant stream introduced into said microreactor comprises alkoxide in alcohol.

17. The microreactor of claim 16 wherein a second reactant stream introduced into said microreactor comprises water in alcohol.

18. The microreactor of claim 1 wherein said reactant streams have flow rates in the range of between about 0.1 μm/min. and about 10 mL/min.

19. The microreactor of claim 1 wherein said colloidal nanoparticles synthesized are Silica.

20. The microreactor of claim 19 wherein the silica nanoparticles are prepared from a tetraethyl-orthosilicate precursor.

21. The microreactor of claim 1 wherein said colloidal nanoparticles synthesized are Titania.

22. The microreactor of claim 21 wherein the titania nanoparticles are prepared from a titanium tetraethoxide precursor.

23. The microreactor of claim 21 wherein the titania nanoparticles are prepared from a titanium n-butoxide precursor.

24. The microreactor of claim 1, wherein the colloidal nanoparticles synthesized are alumina.

25. The microreactor of claim 1, wherein the colloidal nanoparticles synthesized are ceria.

26. The microreactor of claim 1, wherein the colloidal nanoparticles are prepared from one or more compounds represented by the following structural formula: 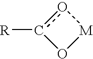
wherein:
M is La, Sr, Mn, Fe, Co, Ce, Gd, Cu, or Ni; and
R is an alkyl, aryl or arylalkyl group.

27. The microreactor of claim 1 wherein said colloidal nanoparticles have monodisperse size distributions.

28. The microreactor of claim 1 wherein said colloidal nanoparticles have polydisperse size distributions.

29. The microreactor of claim 1 wherein said colloidal nanoparticles have precisely defined polydisperse size distribution.

30. The microreactor of claim 1 wherein said colloidal nanoparticles are charged.

31. The microreactor of claim 1 wherein said micromixing block has one or more channels that have a width of between about 1 μm and about 200 μm.

32. The microreactor of claim 1 wherein said micromixing block has one or more channels that have a depth of between about 10 μm and about 2000 μm.

33. The microreactor of claim 1 further comprising a quench fluid inlet port downstream from said aging section and upstream from said at least one outlet channel.

34. The microreactor of claim 33 wherein said quench fluid is an inert solvent.

35. The microreactor of claim 33 wherein said quench fluid is alcohol.

36. The microreactor of claim 33 wherein said quench fluid is introduced into said microreactor at a flow rate equal to or greater than the flow rate of said reacting fluids.

37. The microreactor of claim 33 wherein the introduction of said quench fluid into the microreactor stops the colloidal nanoparticle growth.

38. An electrophoretic switch comprising:
a first inlet channel for introducing a first liquid stream into said electrophoretic switch, wherein the first liquid stream comprises suspended nanoparticles;
a second inlet channel separate from said first inlet channel for introducing a second liquid stream into said electrophorectic switch;
a switch channel downstream from said first and second inlet channels, wherein said first liquid stream and said second liquid stream are contacted at an interface;
at least one negatively charged electrode on one side of the interface;
at least one positively charged electrode on the opposite side of the interface from the at least one negatively charged electrode; and
at least one exit channel downstream from said switch channel.

39. The electrophoretic switch of claim 38, wherein the second liquid comprises a coating reactant.

40. The electrophoretic switch of claim 38, wherein the second liquid is a purification solvent.

41. The electrophoretic switch of claim 38 wherein said nanoparticles are transferred in the switch channel from said first liquid stream to said second liquid stream by electrophoresis.

42. The electrophoretic switch of claim 38 wherein said nanoparticles are transferred in the switch channel from said first liquid stream to said second liquid stream by dielectrophoresis.

43. The electrophoretic switch of claim 38 wherein the width of said switch channel is in the range of between about 1 μm and about 5 mm.

44. The electrophoretic switch of claim 38 wherein the depth of said switch channel is in the range of between about 10 μm and about 2000 μm.

45. The electrophoretic switch of claim 38 wherein the length of said switch channel is in the range of between about 1 mm and about 1 m.

46. The electrophoretic switch of claim 38 wherein said contacted liquids are separated at said at least one exit channel.

47. The electrophoretic switch of claim 38 wherein said at least one exit channel further comprises:
a first exit channel for exiting liquid waste; and
a second exit channel separate from, and adjacent to, said first exit channel for exiting nanoparticles.

48. The electrophoretic switch of claim 38 wherein the reactant streams have a flow rate in the range of between about 1 μL/min and about 100 μL/min at said at least one exit channel.

49. The electrophoretic switch of claim 38 wherein said electrodes are made of a material selected from the group consisting of gold, platinum, copper, nickel, silver, palladium, indium-tin oxide, and combinations thereof.

50. The electrophoretic switch of claim 38 wherein a voltage applied across said electrodes is in the range of between about 0.1 V DC and about 120 V DC.

51. An apparatus for synthesizing colloidal nanoparticles, coating colloidial nanoparticles, or both synthesizing and coating colloidal nanoparticles comprising the following components:
at least one microreactor; and
at least one electrophoretic switch, wherein each component is connected to at least one other component.

52. The apparatus of claim 51, wherein each component is a separate module.

53. The apparatus of claim 51, wherein all components are on the same module.

54. The apparatus of claim 51, wherein all of the components are connected in series.

55. The apparatus of claim 51, further comprising an ultrasonication means.

56. The apparatus of claim 55, wherein the ultrasonication means is an ultrasonication bath into which the microreactor or a portion thereof is emersed.

57. The apparatus of claim 55, wherein the ultrasonification means is an ultrasonification transducer that is attached to the microreactor.

58. The apparatus of claim 51 wherein said microreactor comprises:
at least one micromixing block positioned downstream from at least one inlet channel;
an aging section positioned downstream from said at least one micromixing block channel; and
at least one outlet channel positioned downstream from said aging section.

59. The apparatus of claim 58 wherein the width of said at least one inlet channel is in the range of between about 10 μm-5000 μm.

60. The apparatus of claim 58 wherein the depth of said at least one inlet channel is in the range of between about 10 μm to about 2000 μm.

61. The apparatus of claim 58 wherein said aging section comprises at least one aging channel.

62. The apparatus of claim 61 wherein the length of said at least one aging channel is in the range of between about 1 mm and about 100 cm.

63. The apparatus of claim 61 wherein the width of said at least one aging channel is in the range of between about 10 μm and about 5000 μm.

64. The apparatus of claim 61 wherein the depth of said at least one aging channel is in the range of between about 10 μm and about 2000 μm.

65. The apparatus of claim 58 wherein a first reactant stream is introduced into said microreactor at a first inlet channel.

66. The apparatus of claim 65 wherein a second reactant stream is introduced into said microreactor at a second inlet channel.

67. The apparatus of claim 66 wherein a third reactant stream is introduced into said microreactor at a third inlet channel.

68. The apparatus of claim 58 wherein more than one reactant stream are introduced into said microreactor through one inlet channel.

69. The apparatus of claim 66 wherein a first reactant stream introduced into the microreactor comprises alkoxide in alcohol.

70. The apparatus of claim 69 wherein a second reactant stream introduced into the microreactor comprises water in alcohol.

71. The apparatus of claim 51 wherein said reactant streams have flow rates in the range of between about 0.1 μL/min. to about 10 μl/min.

72. The apparatus of claim 51 wherein said microreactor employs solution-based sol-gel processing.

73. The apparatus of claim 72 wherein said colloidal nanoparticles synthesized are Silica.

74. The apparatus of claim 73 wherein the silica nanoparticles are prepared from a tetraethyl-orthosilicate precursor.

75. The apparatus of claim 51 wherein said colloidal nanoparticles synthesized are Titania.

76. The apparatus of claim 75 wherein the titania nanoparticles are prepared from a titanium tetraethoxide precursor.

77. The apparatus of claim 75 wherein the titania nanoparticles are prepared from a titanium n-butoxide precursor.

78. The apparatus of claim 72, wherein the colloidal nanoparticles synthesized are alumina.

79. The apparatus of claim 72, wherein the colloidal nanoparticles synthesized are ceria.

80. The apparatus of claim 72, wherein the colloidal nanoparticles are prepared from one or more compounds represented by the following structural formula: 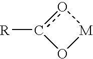
wherein:
M is La, Sr, Mn, Fe, Co, Ce, Gd, Cu, or Ni; and
R is an alkyl, aryl or arylalkyl group.

81. The apparatus of claim 51 wherein said colloidal nanoparticles prepared have monodisperse size distributions.

82. The apparatus of claim 51 wherein said colloidal nanoparticles have polydisperse size distributions.

83. The apparatus of claim 51 wherein said colloidal nanoparticles have precisely defined polydisperse size distribution.

84. The apparatus of claim 51 wherein said colloidal nanoparticles are charged.

85. The apparatus of claim 58 further comprising a quench fluid inlet port downstream from said aging section and upstream from said at least one outlet channel.

86. The apparatus of claim 85 wherein said quench fluid is an inert solvent.

87. The apparatus of claim 85 wherein said quench fluid is alcohol.

88. The apparatus of claim 85 wherein said quench fluid is introduced into said microreactor at a flow rate equal to or greater than the flow rate of said reacting fluids.

89. The apparatus of claim 51, wherein said at least one electrophoretic switch comprises:
a first inlet channel for introducing a first liquid stream into said electrophoretic switch, wherein the first liquid stream comprises suspended nanoparticles;
a second inlet channel separate from said first inlet channel for introducing a second liquid stream into said electrophorectic switch;
a switch channel downstream from said first and second inlet channels, wherein said first liquid stream and said second liquid stream are contacted at an interface;
at least one negatively charged electrode on one side of the interface;
at least one positively charged electrode on the opposite side of the interface from the at least one negatively charged electrode; and
at least one exit channel downstream from said switch channel.

90. The apparatus of claim 89, wherein the second liquid comprises a coating reactant.

91. The apparatus of claim 89, wherein the second liquid is a purification solvent.

92. The apparatus of claim 89 wherein said nanoparticles are transferred in the switch channel from said first liquid stream to said second liquid stream by electrophoresis.

93. The apparatus of claim 89 wherein said nanoparticles are transferred in the switch channel from said first liquid stream to said second liquid stream by dielectrophoresis.

94. The apparatus of claim 89 wherein the width of said switch channel is in the range of between about 1 μm and about 5 mm.

95. The apparatus of claim 89 wherein the depth of said switch channel is in the range of between about 10 μm and about 2000 μm.

96. The apparatus of claim 89 wherein the length of said switch channel is in the range of between about 1 mm and about 1 m.

97. The apparatus of claim 89 wherein said contacted liquids are separated at said at least one exit channel.

98. The apparatus of claim 89 wherein said at least one exit channel further comprises:
a first exit channel for exiting liquid waste; and
a second exit channel separate from, and adjacent to, said first exit channel for exiting nanoparticles.

99. The apparatus of claim 89 wherein the reactant streams have a flow rate in the range of between about 1 μL/min and about 100 μL/min at said at least one exit channel.

100. The apparatus of claim 89 wherein said electrodes are made of a material selected from the group consisting of gold, platinum, copper, nickel, silver, palladium, indium-tin oxide, and combinations thereof.

101. The apparatus of claim 89 wherein a voltage applied across said electrodes is in the range of between about 0.1 V DC and about 120 V DC.

102. The apparatus of claim 89, comprising:
one microreactor, comprising an aging channel; and
two electrophoretic switches, wherein the first electrophoretic switch is upstream from the microreactor and the second electrophoretic switch is down stream from the microreactor.

103. The apparatus of claim 102, wherein the second liquid of the first electrophoretic switch comprises a coating reactant.

104. The apparatus of claim 103 wherein said contacted liquids of the first electrophoretic switch are separated at said at least one exit channel.

105. The apparatus of claim 104 wherein said at least one exit channel of the first electrophoretic switch further comprises:
a first exit channel for exiting liquid waste; and
a second exit channel connected to the microreactor, separate from, and adjacent to, said first exit channel for exiting nanoparticles.

106. The apparatus of claim 105, wherein the second liquid of the second electrophoretic switch comprises a purification solvent.

107. The apparatus of claim 106 wherein said contacted liquids of the second electrophoretic switch are separated at said at least one exit channel.

108. The apparatus of claim 107 wherein said at least one exit channel of the second electrophoretic switch further comprises:
a first exit channel for exiting liquid waste; and
a second exit channel, separate from, and adjacent to, said first exit channel for exiting nanoparticles.

109. A method of synthesizing and coating colloidal nanoparticles comprising:
introducing reactants for forming said nanoparticles into a microreactor, thereby forming synthesized colloidal nanoparticles in a reaction mixture; and
introducing said reaction mixture into an electrophoretic switch downstream from said microreactor, wherein the electrophoretic switch extracts said nanoparticles from said reaction mixture into a coating liquid, thereby coating said nanoparticles.

110. The method of claim 109, wherein the reactants for forming nanoparticles comprise tetraethyl-silcate and the nanoparticles synthesized are silica nanoparticles.

111. The method of claim 109, wherein the coating liquid comprises an oligonucleotide, peptide or protein and the nanoparticles are coated with said ooigonucleotide, peptide or protein.

112. The method of claim 109, further comprising the steps of:
introducing the coating liquid into an aging channel downstream from said electrophoretic switch; and
introducing said coating liquid into a second electrophoretic switch downstream from said aging channel, wherein the electrophoretic switch extracts the coated nanoparticle into a purification solvent.

113. A method of coating colloidal nanoparticles comprising:
introducing a mixture containing nanoparticles into an electrophoretic switch, wherein the electrophoretic switch extracts said nanoparticles from said mixture into a coating liquid, thereby coating said nanoparticles.

114. The method of claim 113, wherein the coating liquid comprises an oligonucleotide, peptide or protein and the nanoparticles are coated with said ooigonucleotide, peptide or protein.

115. The method of claim 113, further comprising the steps of:
introducing the coating liquid into an aging channel downstream from said electrophoretic switch; and
introducing said coating liquid into a second electrophoretic switch downstream from said aging channel, wherein the electrophoretic switch extracts the coated nanoparticles from said coating liquid into a purification solvent.
